(19) United States
(12) Patent Application Publication
(10) Pub. No.: US 2012/0156655 A1
(43) Pub. Date: Jun. 21, 2012

(54) Polarized Instrument Flight Training System

(76) Inventor: Guy Goldberg, Houston, TX (US)

(21) Appl. No.: 13/299,343

(22) Filed: Nov. 17, 2011

Related U.S. Application Data
(60) Provisional application No. 61/424,671, filed on Dec. 19, 2010.

(51) Int. Cl. G09B 9/08; B23P 11/00

(52) U.S. Cl. 434/38; 29/428

(57) ABSTRACT

This disclosure describes a system and method of an instrument flight training system that provides student pilots with simulation of instrument flight conditions. This is accomplished by obscuring the outside world using two cross-polarizing filters, one on the windshield and one on the student pilot's glasses, while still providing a view of all of the flight instruments inside of the cockpit to the student pilot, while providing a view of the outside world to a second pilot who is not wearing the glasses.

### CROSS REFERENCE TO RELATED APPLICATIONS

The present application claims the benefit of the filing date of U.S. provisional patent application Ser. No. 61/424,671, filed on 19 Dec. 2010, the disclosure of which is incorported herein by reference.

### FIELD OF THE INVENTION

This invention relations to flight training devices, and more specifically instrument meterological condition flight training devices.

### BACKGROUND OF THE INVENTION

The invention described will be used to simulate instrument meteorological conditions (IMC) for flight training In order to obtain an Instrument Flight Rules (IFR) rating, pilots must become proficient in flying using reference to instruments only, thereby being able to fly safely in conditions of no outside visibility, i.e. in clouds. The most common training method is to use a device that visually restricts the pilot's ability to view outside visual references, thereby simulating IMC. The current devices used today only partially restrict the pilot's ability to view outside visual references when work. The existing devices are generally hoods, visors, or glasses that use a physical obstruction to block the straight ahead and upward line of sight, preventing the pilot from seeing out of the windshield of the aircraft. However, none of these devices are effective in completely obscuring the outside world, and the devices cannot prevent the student pilot from circumventing the device by tilting his/her head up to look out through the aircraft windshield.

### BRIEF SUMMARY OF THE INVENTION

Therefore, the present invention has been made in view of the above limitations. The view limiting system described herein effectively obscures the outside world to a student pilot, while still allowing an instructor or observer to have an unrestricted view of the outside world and the student pilot to have unrestricted vision of the entire cockpit environment. The system solves the problem of allowing a student pilot to view the outside world by providing an opaque view of the outside world, thereby making it impossible for the student pilot to see anything outside of the cockpit. The system consists of two primary parts. The first part is a transparent, polarized sheet (or set of transparent polarized sheets for every pane of an aircraft windshield) placed on the inside of each pane of the windshield of the aircraft. The second part of the system is a left transparent lens and right transparent lens, cross-polarized with the polarized sheet, covering each eye of the student pilot in such a way that the student pilot cannot see outside of the aircraft, but can see everything normally inside the flight deck of the aircraft.

### BRIEF DESCRIPTION OF THE FIGURES

FIG. 1 is a view of the aircraft flight deck showing the transparent polarized sheet as it is affixed to the windshield viewed through a polarized lens.

FIG. 2 is a view of the installation of a transparent polarized sheet onto an inside of a pane of a windshield of an aircraft, as viewed through a polarized lens.

FIG. 3 is a view of one embodiment of an installation mechanism for a transparent polarized sheet.

FIG. 4 is a view of one embodiment of sizing a polarized sheet to fit a pane of an aircraft windshield.

FIG. 5 is a perspective view of one embodiment of a polarized lens installed in fixed frame spectacles.

FIG. 6 is a perspective view of one embodiment of a polarized lens installed in Clip-on frame spectacles.

FIG. 7 is a perspective view of one embodiment of a polarized lens installed in flip-up frame spectacles.

FIG. 8 is a view of one embodiment of a Roll-up ratcheting mechanism for a transparent polarized sheet.

FIG. 9 is a view of one embodiment of the layers necessary for manufacture of a polarized lens.

### DETAILED DESCRIPTION OF THE INVENTION

The ability to fly IMC is an essential skill for any pilot to allow safe flying and landing of any aircraft under conditions of little or no visibility, as weather is sometimes unpredictable. The primary objective of my invention is to provide an instrument flight training system that adequately limits the pilot's vision to the scope of the instrument panel with the ability to also be easily disengaged/removed when required in the interest of safe flying. In this disclosure, the use of the terms cross polarize, cross polarized, and any similar form of the term indicates two separate polarized materials that are oriented 90 degrees from each other, thereby effectively blocking out all light when viewing through both materials.

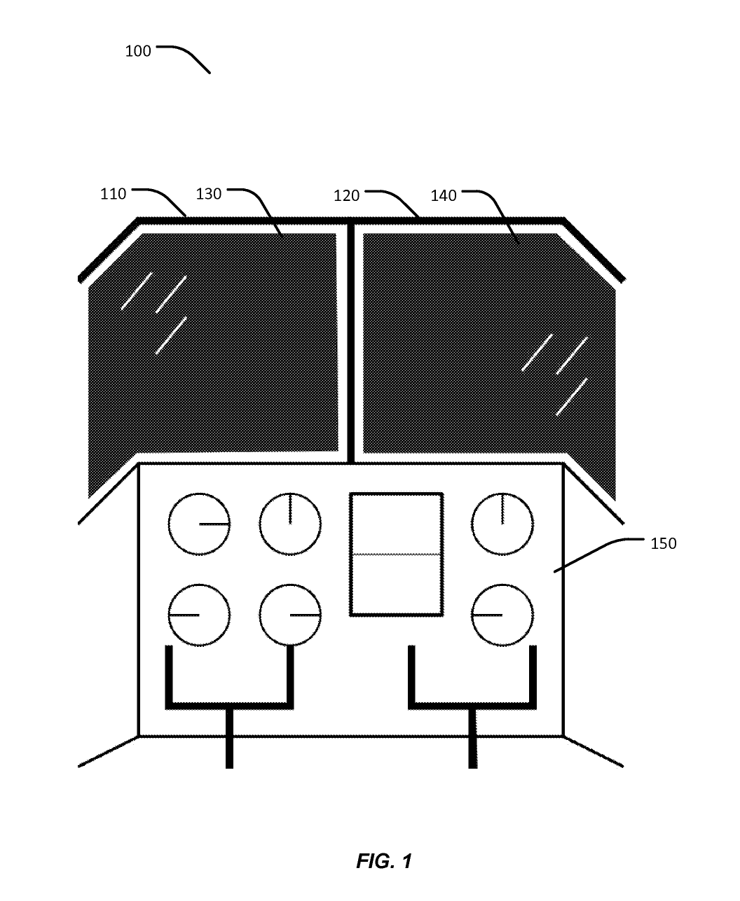

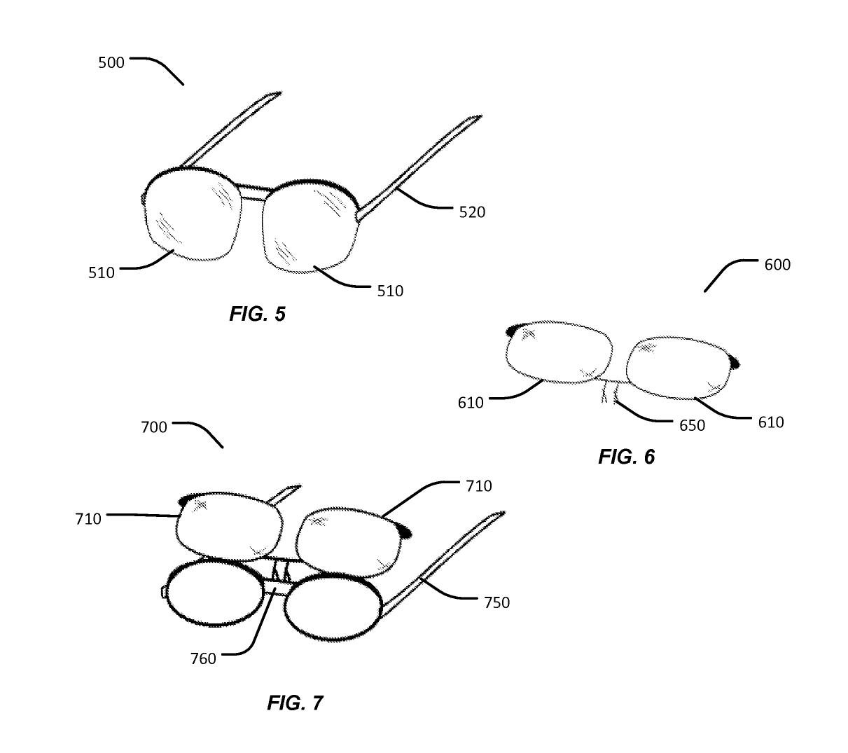

With respect to the figures: FIG. 1 is a perspective view of the polarized instrument flight training system 100 from the perspective of a student pilot wearing polarized lens (shown in FIGS. 5-7) cross polarized with a left transparent polarized sheet 130 and a right transparent polarized sheet 140. In one embodiment, a left aircraft windshield pane 110 is covered by a left transparent polarized sheet 130 and a right aircraft windshield pane 120 is covered by a right transparent polarized sheet 140. When viewed through a polarized lens that is cross polarized with the left transparent polarized sheet 130 and the right transparent polarized sheet 140, the ability of a student pilot to view outside of the aircraft through the left aircraft windshield pane 110 and the right aircraft windshield pane 120 is restricted. In a particular embodiment, the left transparent polarized sheet 130 and the right transparent polarized sheet 140 are fitted to approximately the size and shape of a particular aircraft windshield pane. In the example, the view of aircraft flight deck 150 is completely unrestricted for the student pilot wearing a polarized lens. As this is an exemplary embodiment, it is understood a particular aircraft may have more or less than two aircraft windshield panes.

This allows a student pilot to simulate instrument meteorological conditions for training, while allowing the instructor the ability to monitor the outside world for potential unsafe conditions. In a particular embodiment, the left transparent polarized sheet 130 and the right transparent polarized sheet 140 include a single sheet coving all panes of an aircraft windshield. A particular embodiment of the left transparent polarized sheet 130 and the right transparent polarized sheet 140 includes a Polyvinyl Alcohol-Iodine filter material. In a particular embodiment, the left transparent polarized sheet 130 and the right transparent polarized sheet 140 are approximately 0.15 mm thick. Alternate embodiments of the transparent polarized sheet include any transparent materials with the ability to be linearly polarized.

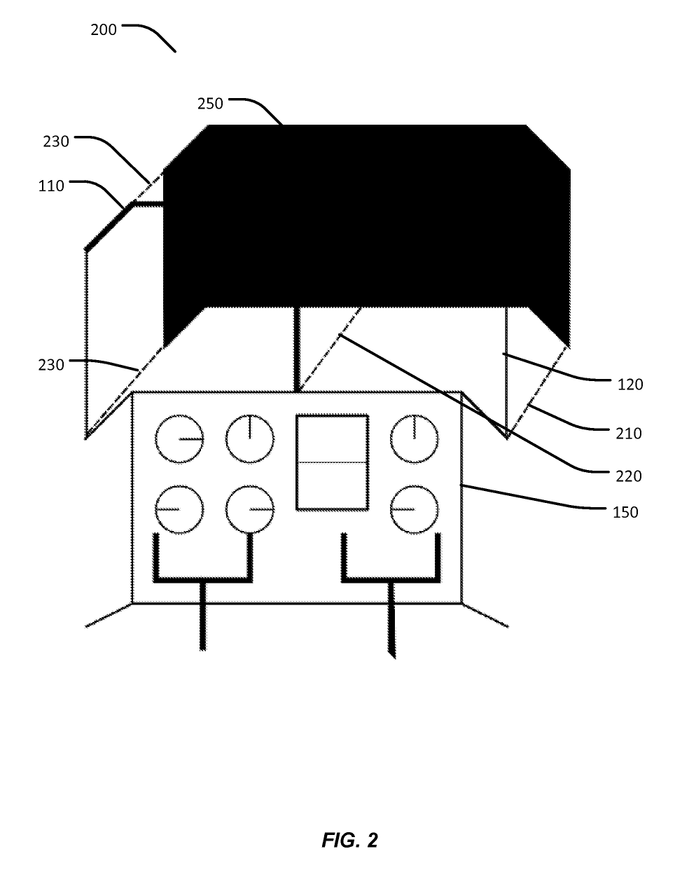

FIG. 2 is a view of a polarized instrument flight training system installation 200. The single transparent polarized sheet 250 is installed over the left aircraft windshield pane 110 and the right aircraft windshield pane 120. Dotted lines 210, 220, 230, 240 illustrate the transparent polarized sheet 250 moving into place over the left aircraft windshield pane 110 and the right aircraft windshield pane 120. The transparent polarized sheet 250 is shown as viewed through a polarized lens that is cross polarized with the transparent polarized sheet 250. The transparent polarized sheet 250 is affixed over the left aircraft windshield pane 110 and the right aircraft windshield pane 120 via a means for affixing the transparent polarized sheet 250. The means for affixing the transparent polarized sheet 250 must provide sufficient clarity for safely flying an aircraft under Visual Flight Rules (VFR) when viewed with the naked eye. In exemplary embodiments, the means for affixing the transparent polarized sheet 250 may include a ratcheting roller tube, suction cups, adhesive, and static cling glass film. In a particular embodiment, the means for affixing the transparent polarized sheet 250 provides for easy installation and removal. In a particular embodiment, the transparent polarized sheet 250 is able to be re-used over and over again, and transferred to various aircraft platforms. In a particular embodiment, the transparent polarized sheet 250 is a single sheet coving all panes of an aircraft windshield. A particular embodiment of the transparent polarized sheet 250 includes a Polyvinyl Alcohol-Iodine filter material. In a particular embodiment, the transparent polarized sheet 250 is approximately 0.15 mm thick.

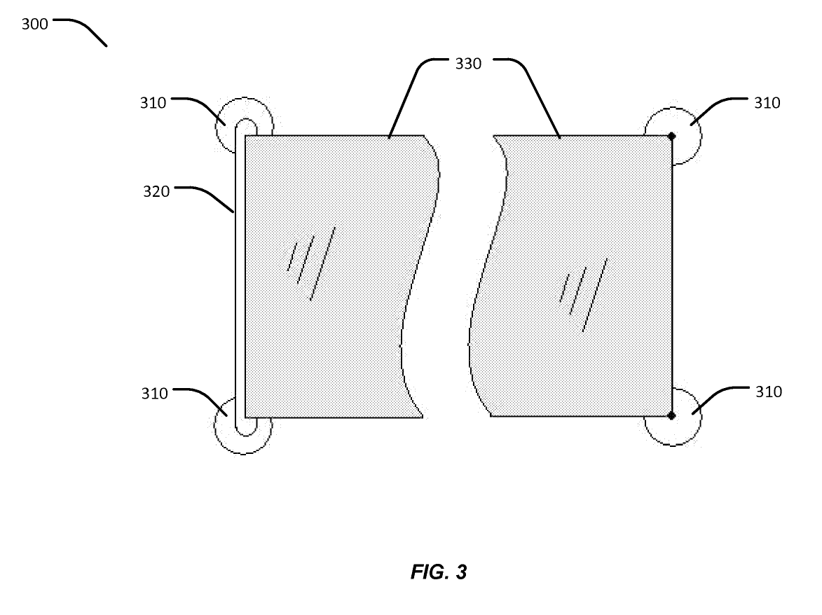

FIG. 3 shows a transparent polarized sheet affixing mechanism 300. The transparent polarized sheet 330 contains four suction cups 310. In the exemplary embodiment, the suction cup 310 is affixed to the transparent polarized sheet 330 at each corner. In alternate embodiments, the use of more or less of the suction cups 310 as required to adequately affix the transparent polarized sheet 330 to over the aircraft windshield is understood. In an optional embodiment, a roll-up ratcheting mechanism 320 provides a means for rolling up the transparent polarized sheet 330 for easy transport and storage, as well as a means to quickly remove the transparent polarized sheet 330 from the aircraft windshield.

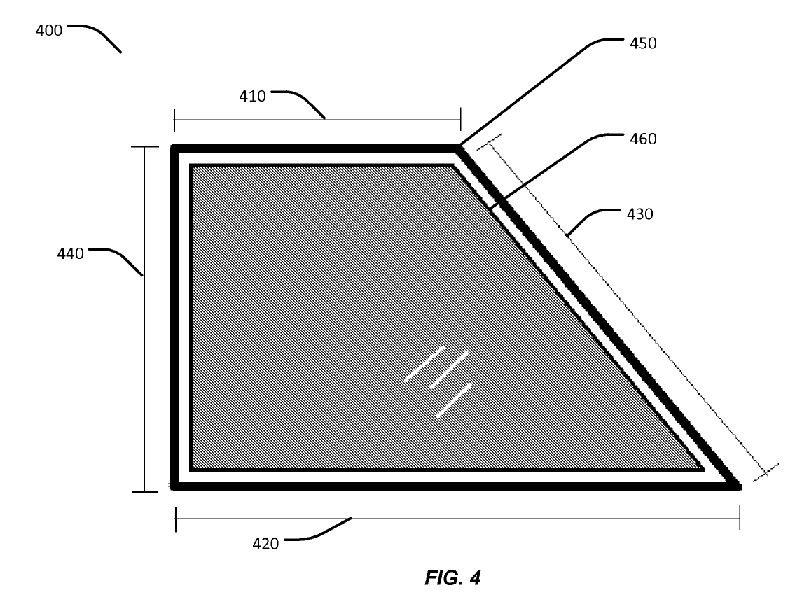

FIG. 4 is an illustration of sizing of a transparent polarized sheet 400. An aircraft windshield pane 450 is covered with a transparent polarized sheet 460. In a particular embodiment, the transparent polarized sheet 460 is cut to the approximate dimensions of the aircraft windshield pane 450, i.e. a top length 410, a bottom length 420, a right length 430, and a left length 440. It is understood that aircraft windshield panes are designed in various shapes and sizes. In an alternate embodiment, one transparent polarized sheet 460 is used to cover more than one aircraft windshield pane 450.

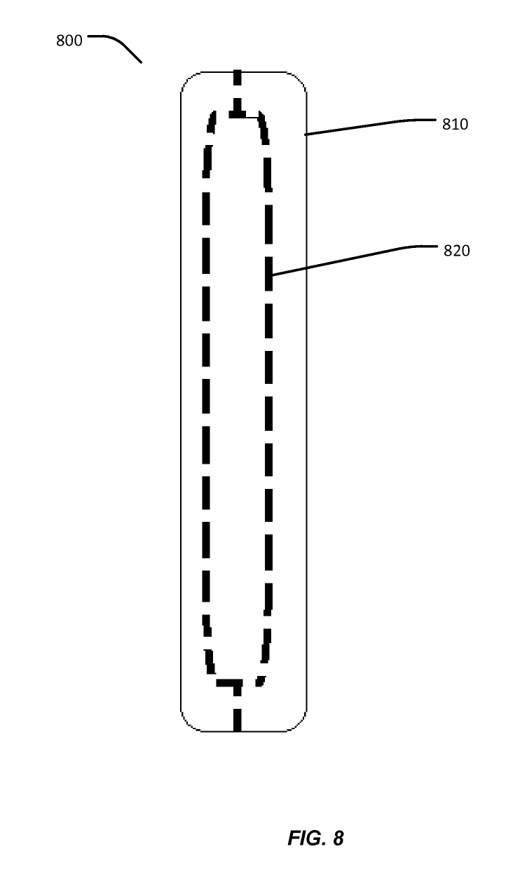

FIG. 5, FIG. 6, and FIG. 7 illustrate various exemplary embodiments for the polarized lens worn by the student pilot. It is understood that there are an indefinite number of eyeglass frame types, and this disclosure is not intended to be limited to the embodiments described herein, including those with a single lens covering both eyes. FIG. 5 is a perspective view of fixed frame spectacles 500, having a polarized lens 510 installed in the left and right side of fixed frame 550. The polarized lens 510, when installed in the fixed frame 550, are cross polarized with the transparent polarized sheet when worn by the student pilot.

FIG. 6 is a perspective view of clip-on frame spectacles 600, having a polarized lens 610 installed in the left and right side of clip-on frame 650. The polarized lens 610, when installed in the clip-on frame 650, are cross polarized with the transparent polarized sheet when worn by the student pilot. In a particular embodiment, the clip-on frame spectacles 600 can be clipped onto a pair of eyewear worn by the student pilot. This allows a student requiring vision correction to easily use this flight training system.

FIG. 7 is a perspective view of flip-up frame spectacles 700, having a polarized lens 710 installed in the left and right side of clip-up frame 750. The polarized lens 710, when installed in the clip-up frame 750, are cross polarized with the transparent polarized sheet when worn by the student pilot. The polarized lens 710 can be moved away from the eyes of the student pilot by rotating a clip-up frame hinge mechanism 760 to move the polarized lens 710. This allows the student pilot easily remove the polarized lens away from the eyes and view outside the aircraft in an emergency condition.

FIG. 8 is a particular embodiment of a roll-up ratcheting mechanism 800. The mechanism contains a roller housing 810 containing a roll with a transparent polarized sheet 820. The roll-up ratcheting mechanism 800 is an embodiment that allows for ease of storage and transport to and from various aircraft platforms.

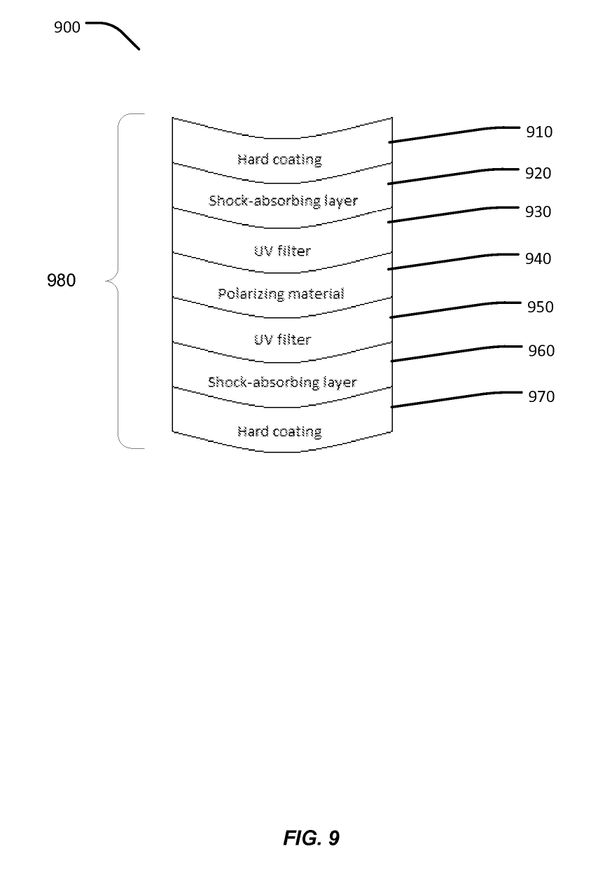

FIG. 9 is an exemplary embodiment of a polarized lens manufacture 900. In this particular embodiment, a polarized lens 980 contains several layers. The layers are a hard coating 910, a shock-absorbing layer 920, an ultraviolet light filter 930, a polarizing material 940, an ultraviolet light filter 950, a shock-absorbing layer 960, and a hard coating 970. In a particular embodiment, the polarizing material 940 includes a Polyvinyl Alcohol-Iodine filter material. As this is a particular exemplary embodiment of the polarized lens 980, it is understood that the polarized lens 980 could contain the various layers in a slightly different order, or contain a subset of these layers. In addition, the polarized lens 980 may also include additional layers.

To employ the polarized instrument flight training system, the transparent polarized sheet transparent polarized sheet 250 in FIG. 2 is installed onto the inside of the left aircraft windshield pane 110 and right aircraft windshield pane 120 (FIGS. 1 and 2). The student pilot places the polarized lens (examples: the polarized lens 510 in FIG. 5, the polarized lens 610 in FIG. 6, and the polarized lens 710 in FIG. 7) over his/her eyes. In this position, the two polarized surfaces are cross polarized, meaning the surfaces interfere with each other to become opaque and black out the view outside of the left aircraft windshield pane 110 and right aircraft windshield pane 120, while still allowing the pilot to see all displays and instruments inside the aircraft flight deck 150 in FIG. 1. In this manner, the student pilot is able to fly with reference only to the information provided by the flight instruments in aircraft flight deck 150 in FIG. 1. At an appropriate point in time, the student pilot can remove the polarized lens (examples: the polarized lens 510 in FIG. 5, the polarized lens 610 in FIG. 6, and the polarized lens 710 in FIG. 7) to quickly get an unobstructed vision of the outside world through the left aircraft windshield pane 110 and the right aircraft windshield pane 120 in FIG. 1. Throughout this entire time, a second person (instructor pilot or observation pilot) will be able to view the outside world at all times, since the sheet placed over the windshield is transparent to light when viewed by itself. This feature ensures the safe operation of each flight. Additionally, the transparent sheet 250 can be easily and quickly removed either in flight, or on the ground for quick installation and removal.

What is claimed is:

1. A polarized Instrument flight training system comprises:
a transparent polarized sheet covering an aircraft windshield; and
a transparent polarized lens used to cover each eye of a wearer, wherein the transparent polarized lens is cross polarized with the transparent polarized sheet.

2. The polarized instrument flight training system of claim 1, wherein the transparent polarized sheet further comprises:
a means for installation and removal from the aircraft windshield.

3. The polarized instrument flight training system of claim 1 further comprises:
a pair of fixed spectacle frames, wherein the transparent polarized lens is installed in the fixed spectacle frames.

4. The polarized instrument flight training system of claim 1 further comprises:
a pair of clip-on spectacle frames, wherein the transparent polarized lens is installed in the clip-on spectacle frames., wherein the clip-on spectacle frame comprises a clip on mechanism for attaching the clip-on spectacle frames to spectacles worn by the wearer.

7. The polarized instrument flight training system of claim 1 further comprising:
a pair of flip-up spectacle frames, wherein the transparent polarized lens is installed in the flip-up spectacle frames.

8. The polarized instrument flight training system of claim 2, wherein the means for removal and re-installation from the aircraft windshield includes suction cups, adhesive, and static cling glass film.

9. The polarized Instrument flight training system of claim 1, wherein the transparent polarized sheet covering an aircraft windshield comprises at least one transparent polarized piece sized to fit a pane of the aircraft windshield.

10. The polarized Instrument flight training system of claim 1 further comprising a roll-up ratcheting mechanism, wherein the roll-up ratcheting mechanism comprises a roll-up housing, and a roll of the transparent polarized sheet.

11. The polarized Instrument flight training system of claim 1, wherein the transparent polarized lens comprises a hard coating, a shock-absorbing layer, an ultraviolet light filter, a polarizing material, an ultraviolet light filter, a shock-absorbing layer, and a hard coating.

12. The polarized Instrument flight training system of claim 1, wherein the transparent polarized lens includes a Polyvinyl Alcohol-Iodine filter.

13. The polarized Instrument flight training system of claim 1, wherein the transparent polarized sheet includes a Polyvinyl Alcohol-Iodine filter.

14. The polarized Instrument flight training system of claim 1, wherein the transparent polarized sheet is approximately 0.15 mm thick.

15. A method for installing a polarized flight training system comprising:
affixing a first transparent polarized sheet to cover at least one aircraft windshield pane; and
placing a spectacle frame on a wearer, the spectacle frame comprising a polarized lens, wherein the polarized lens is cross polarized with the first transparent polarized sheet.

16. The method for installing a polarized flight training system of claim 15 further comprising:
affixing a second transparent polarized sheet to cover a second aircraft windshield pane.

17. The method for installing a polarized flight training system of claim 16 further comprising affixing a second transparent polarized sheet to a second aircraft windshield pane, wherein polarization of the second transparent polarized sheet is parallel to the first transparent polarized sheet.

18. The method for installing a polarized flight training system of claim 15, wherein the pair of spectacle frames further includes one of a fixed spectacle frame, a clip-on spectacle frame, and a flip-up spectacle frame.

19. The method for installing a polarized flight training system of claim 15, wherein affixing includes at least of suction cups, adhesive, and static cling glass film.
